(19) United States
(12) Patent Application Publication
(10) Pub. No.: US 2005/0228122 A1
(43) Pub. Date: Oct. 13, 2005

(54) Esteramide compositions, copolymers and blends thereof

(75) Inventors: Ganesh Kannan, Bangalore (IN); Abbas-Alli Ghudubhai Shaikh, Bangalore (IN); Sachin Ashok Shelukar, Bangalore (IN); A. S. Radhakrishna, Bangalore (IN); Timmanna Upadhya, Bangalore (IN); Manickam Jayakannan, Trivandrum (IN); Govindagouda Shreenivasa Patil, Bangalore (IN)

Correspondence Address: Robert E. Walter;GE Plastics, One Plastics Avenue, Pittsfield, MA, 01201, US

(73) Assignee: General Electric Company

(21) Appl. No.: 10/815,001

(22) Filed: Mar. 31, 2004

(51) Int. Cl. C08K 3/00; C08L 79/00

(52) U.S. Cl. 524/599; 528/271

(57) ABSTRACT

Novel esteramide compositions have been discovered. Copolymer composition comprising structural units derived from a substituted or unsubstituted diacid, a substituted or unsubstituted diol and said ester amide have also been disclosed. Also disclosed is a thermoplastic resin composition comprising structural units derived from substituted or unsubstituted polycarbonate and the copolyesteramides of the present invention. In addition methods for the preparation of the esteramides, copolymers and thermoplastic composition is discussed and articles derived from said thermoplastic composition is disclosed.

### BACKGROUND OF THE INVENTION

This invention relates to esteramides, more particularly to copolyesters of the esteramides, and blends of these copolyesters with thermoplastic resins, which have enhanced heat stability.

Many applications of engineering plastics require polymers that have high heat stability along with other properties such as tensile strength and chemical resistance. Conventional commercial polyesters generally are deficient in Tg and thus heat stability, but possess other desired property attributes such as excellent mechanical properties, good surface finishes of molded articles and satisfactory chemical resistance.

Many polyesteramides are well known in the art. U.S. Pat. No. 2,547,113 discloses a sequential addition process for the preparation of polyesteramides based on high melting aromatic diamines, diacids and diols. U.S. Pat. No. 5,672,676 describes a polyesteramide prepared by sequential addition process where the diamine is added after some preliminary step-growth condensation has occurred. European Patent Number 0608976 discloses block copolymers comprising polyether chains as soft segment in combination with aromatic oligoamide chains as hard segment and also the processes for producing the block copolymers.

The primary object of the invention is to provide a novel esteramide copolymer material and its blend with a thermoplastic resin having excellent heat resistance, cold resistance, processability, strength and moldability properties.

There is a continuing need for polycarbonate polyester blends having a good balance of transparency, processability, solvent resistance and environmental stress cracking resistance in addition to good mechanical and thermal properties.

### BRIEF DESCRIPTION OF THE INVENTION

The present inventors have unexpectedly discovered an ester amide composition of the formula:
Y—R—X;
wherein R is independently selected from the group consisting of a substituted or unsubstituted alkenyl, allyl, alkyl, substituted aryl, aralkyl, alkaryl, or cycloalkyl; X is of the formula: 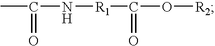
wherein R₁ and R₂ are independently selected from the group consisting of a substituted and unsubstituted alkenyl, allyl, alkyl, aryl, aralkyl, alkaryl, or cycloalkyl groups; and Y is independently selected from a group consisting of said X, COOR₃ group wherein R₃ independently selected from the group consisting of a substituted and unsubstituted alkenyl, allyl, alkyl, aryl, aralkyl, alkaryl, or cycloalkyl groups.

In one embodiment of the present invention is disclosed the method of synthesis of the esteramides. In addition, also disclosed is a copolymer composition comprising: structural units derived from a substituted or unsubstituted diacid, a substituted or unsubstituted diol and said ester amide of the present invention and the method of synthesizing the copolymer. Also disclosed is a thermoplastic resin composition comprising structural units derived from substituted or unsubstituted polycarbonate and the copolyesteramides of the present invention, method for the preparation of these thermoplastic resin compositions of the present invention and articles derived from said composition.

Various other features, aspects, and advantages of the present invention will become more apparent with reference to the following description, examples, and appended claims.

### DETAILED DESCRIPTION OF THE INVENTION

The present invention may be understood more readily by reference to the following detailed description of preferred embodiments of the invention and the examples included herein. In this specification and in the claims, which follow, reference will be made to a number of terms which shall be defined to have the following meanings.

The singular forms “a”, “an” and “the” include plural referents unless the context clearly dictates otherwise.

“Optional” or “optionally” means that the subsequently described event or circumstance may or may not occur, and that the description includes instances where the event occurs and instances where it does not.

As used herein the term “polycarbonate” refers to polycarbonates incorporating structural units derived from one or more dihydroxy aromatic compounds and includes copolycarbonates and polyester.

As used herein the term “PCCD” is defined as poly(cyclohexane-1,4-dimethylene cyclohexane-1,4-dicarboxylate).

The present inventors have unexpectedly discovered an ester amide composition of the formula (I):
Y—R—X (I);
wherein R is independently selected from the group consisting of a substituted or unsubstituted alkenyl, allyl, alkyl, substituted aryl, aralkyl, alkaryl, or cycloalkyl; X is of the formula (II) 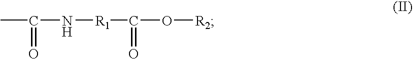
wherein R₁ and R₂ are independently selected from the group consisting of a substituted and unsubstituted alkenyl, allyl, alkyl, aryl, aralkyl, alkaryl, or cycloalkyl groups; and Y is independently selected from a group consisting of said X, COOR₃ group wherein R₃ independently selected from the group consisting of a substituted and unsubstituted alkenyl, allyl, alkyl, aryl, aralkyl, alkaryl, or cycloalkyl groups.

In one embodiment of the present invention the ester amide is a diester amide. In another embodiment the esteramide is a diesteramide. The R is selected from the group consisting of a substituted or unsubstituted alkenyl, allyl, alkyl, substituted aryl, aralkyl, alkaryl, or cycloalkyl. In one embodiment the R is selected from a group consisting of alkyl, cycloalkyl, aralkyl containing at least about C₄-C₂₆ carbon atoms. In an alternate embodiment the R is independently selected from C₆ - C₁₈ aliphatic, alkylaryl and arylalkyl groups. In another embodiment, R is independently selected from substituted and unsubstituted hexyl, heptyl, n-octyl, iso-octyl, tricyclodecyl, n-decyl, iso-decyl, 2-benzylheptyl, dodecyl, tetradecyl, hexadecyl, octadecyl cyclo hexyl, cyclo heptyl, cyclo octyl, cyclo-dodecyl, cyclo- tetradecyl, cyclo- hexadecyl groups, phenyl, naphthyl, partially or completely hydrogenated naphthyl groups.

In one embodiment of the present invention R₁ and R₂ are independently selected from the group consisting of a substituted and unsubstituted alkenyl, allyl, alkyl, aryl, aralkyl, alkaryl, or cycloalkyl groups. In one embodiment the R₁ is a substituted or unsubstituted aryl group. In another embodiment the R₁ is a phenyl group. The R₂ and R₃ is independently selected from a group consisting of substituted or unsubstituted alkyl groups consisting of at least C₁ to C₁₀ carbon atoms. In an alternate embodiment the R₂ and R₃ is independently a methyl, ethyl, propyl group.

The method of synthesis of the esteramides of the present invention a diacid is heated with a chlorinating agent in presence of a catalyst to form a first mixture. Optionally a diester is hydrolysed to form a diacid, which is then reacted with the chlorinating agent. The diester employed in one embodiment of the present invention is of the formula (III) 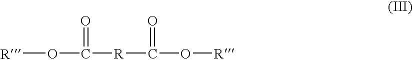
wherein R is as described earlier and R′″ is independently at least one selected from the group consisting of hydrogen, substituted or unsubstituted alkyl, substituted or unsubstituted aryl groups. In one embodiment of the present invention R′″ is independently at least one selected from the group consisting of hydrogen, substituted or unsubstituted alkyl groups containing about C₁ to C₁₅ carbon atoms. In another embodiment R′″ is independently at least one hydrogen, methyl, ethyl and propyl groups.

The chlorinating agent is independently at least one selected from the group consisting of phosphorous tirchloride, phosphorous pentachloride, antimony chlorides, phosphorous oxy chloride, sulphuryl chloride, thionyl chloride, alkali and alkaline salts of hypochlorites, carbon tetrachloride, chloroform, salts of dichlorocyanurate, salts of trichlorocyanurate and mixtures thereof. In one embodiment of the present invention the chlorinating agent is thionyl chloride.

The catalyst employed is a hydrogenation catalyst selected from the group consisting of nickel, palladium, rhodium catalysts, charcoal or mixtures thereof. In one embodiment the catalyst is one selected from the group consisting of nickel on at least about 5% charcoal, palladium on at least about 5% charcoal. Optionally in one embodiment the heating is carried out in presence of a solvent, preferably an aromatic solvent selected from the group consisting of benzene, chlorobenzene, dichlorobenzene, methylene chloride, chloroform, tetrahydrofuran, dioxane, dichloromethane, diethyl ether, xylene, toluene, and the like. In another embodiment the solvent is toluene.

In one embodiment the first mixture is reacted with an alkyl aminoarylate in presence of a second catalyst to form the esteramide of the present invention. In one embodiment the alkyl amino arylate is obtained from the aromatic aminocarboxylic acid compounds include but are not limited to alkyl (e.g., methyl, ethyl. propyl and butyl) esters of aminocarboxylic acids: for example, aminobenzoic acids, such as 4-amino benzoic acid and 3-amino benzoic acid; biphenyl aminocarboxylic acids, such as 4-amino-4′-carboxy biphenyl, 4-amino-4′-carboxy biphenyl ether, 4-amino-4′-carboxy biphenyl sulfide, and 4-amino-4′-carboxy biphenyl sulfone; aminocarboxy phenones such as 3-amino-3′-carboxy benzophenone, and 4-amino-4′-carboxyphenone; and aminocarboxy naphthalenes, such as 1-amino-4-carboxy naphthalene, and 2-amino-6-carboxy napnthalene. In one embodiment the alkyl aminoarylate is an alkyl aminobenzoate, preferred embodiment the alkyl amino benzoate is an ethyl amino benzoate. The second catalyst is selected from a group consisting of nitrogen compounds like ammonium compounds for example but not restricted to trialkyl ammonia salts, wherein the alkyl group is selected from the group consisting of methyl, ethyl, propyl, isopropyl, butyl, isobutyl and mixtures thereof. In a preferred embodiment the catalyst is triethyl ammonia. The reaction is carried out in a temperature range of between about 25° C. and about 90° C. In one embodiment of the present invention the reaction is carried out for a period of at least about 30 minutes to about six hours.

Typically polyester resins include crystalline polyester resins such as polyester resins derived from an aliphatic or cycloaliphatic diol, or mixtures thereof, containing from 2 to about 10 carbon atoms and at least one aromatic dicarboxylic acid. Preferred polyesters are derived from an aliphatic diol and an aromatic dicarboxylic acid and have repeating units according to structural formula (IV) 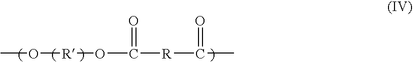
wherein, R′ is an alkyl radical compromising a dehydroxylated residue derived from an aliphatic or cycloaliphatic diol, or mixtures thereof, containing from 2 to about 20 carbon atoms. R is an aryl radical comprising a decarboxylated residue derived from an aromatic dicarboxylic acid. In one embodiment of the present invention the polyester could be an aliphatic polyester where at least one of R′ or R is a cycloalkyl containing radical. The polyester is a condensation product where R′ is the residue of an aryl, alkane or cycloalkane containing diol having 6 to 20 carbon atoms or chemical equivalent thereof, and R is the decarboxylated residue derived from an aryl, aliphatic or cycloalkane containing diacid of 6 to 20 carbon atoms or chemical equivalent thereof. The polyester resins are typically obtained through the condensation or ester interchange polymerization of the diol or diol equivalent component with the diacid or diacid chemical equivalent component.

The diacids meant to include carboxylic acids having two carboxyl groups each useful in the preparation of the polyester resins of the present invention are preferably aliphatic, aromatic, cycloaliphatic. Examples of diacids are cyclo or bicyclo aliphatic acids, for example, decahydro naphthalene dicarboxylic acids, norbomene dicarboxylic acids, bicyclo octane dicarboxylic acids, 1,4-cyclohexanedicarboxylic acid or chemical equivalents, and most preferred is trans-1,4-cyclohexanedicarboxylic acid or a chemical equivalent. Linear dicarboxylic acids like adipic acid, azelaic acid, dicarboxyl dodecanoic acid, and succinic acid may also be useful. Chemical equivalents of these diacids include esters, alkyl esters, e.g., dialkyl esters, diaryl esters, anhydrides, salts, acid chlorides, acid bromides, and the like. Examples of aromatic dicarboxylic acids from which the decarboxylated residue R may be derived are acids that contain a single aromatic ring per molecule such as, e.g., isophthalic or terephthalic acid, 1,2-di(p-carboxyphenyl)ethane, 4,4′-dicarboxydiphenyl ether, 4,4′-bisbenzoic acid and mixtures thereof, as well as acids contain fused rings such as, e.g., 1,4- or 1,5-naphthalene dicarboxylic acids. In a preferred embodiment, the dicarboxylic acid precursor of residue R is terephthalic acid or, alternatively, a mixture of terephthalic and isophthalic acids.

Some of the diols useful in the preparation of the polyester resins of the present invention are straight chain, branched, or cycloaliphatic alkane diols and may contain from 2 to 12 carbon atoms. Examples of such diols include but are not limited to ethylene glycol; propylene glycol, i.e., 1, 2- and 1,3-propylene glycol; 2,2-dimethyl-1,3-propane diol; 2-ethyl, 2-methyl, 1,3-propane diol; 1,3- and 1,5-pentane diol; dipropylene glycol; 2-methyl-1,5-pentane diol; 1,6-hexane diol; dimethanol decalin, dimethanol bicyclo octane; 1,4-cyclohexane dimethanol and particularly its cis- and trans-isomers; triethylene glycol; 1,10-decane diol; and mixtures of any of the foregoing. Preferably, a cycloaliphatic diol or chemical equivalent thereof and particularly 1,4-cyclohexane dimethanol or its chemical equivalents are used as the diol component. Chemical equivalents to the diols include esters, such as dialkylesters, diaryl esters, and the like.

Typically the polyester resin may comprise one or more resins selected from linear polyester resins, branched polyester resins and copolymeric polyester resins. Suitable linear polyester resins include, e.g., poly(alkylene phthalate)s such as, e.g., poly(ethylene terephthalate) (“PET”), poly(butylene terephthalate) (“PBT”), poly(propylene terephthalate) (“PPT”), poly(cycloalkylene phthalate)s such as, e.g., poly(cyclohexanedimethanol terephthalate) (“PCT”), poly(alkylene naphthalate)s such as, e.g., poly(butylene-2,6-naphthalate) (“PBN”) and poly(ethylene-2,6-naphthalate) (“PEN”), poly(alkylene dicarboxylate)s such as, e.g., poly(butylene dicarboxylate).

In one embodiment of the present invention the polyester is an aliphatic polyester where at least one of R′ or R is a cycloalkyl containing radical. In one embodiment at least one R′ or R is cycloaliphatic. Preferred polyesters of the invention will have both R′ and R cycloaliphatic. In one embodiment the present cycloaliphatic polyesters are condensation products of aliphatic diacids, or chemical equivalents and aliphatic diols, or chemical equivalents. The present cycloaliphatic polyesters may be formed from mixtures of aliphatic diacids and aliphatic diols but must contain at least 50 mol % of cyclic diacid and/or cyclic diol components, the remainder, if any, being linear aliphatic diacids and/or diols. The cyclic components are necessary to impart good rigidity to the polyester and to allow the formation of transparent blends due to favorable interaction with the polycarbonate resin.

R′ and R are preferably cycloalkyl radicals independently selected from the following formula:

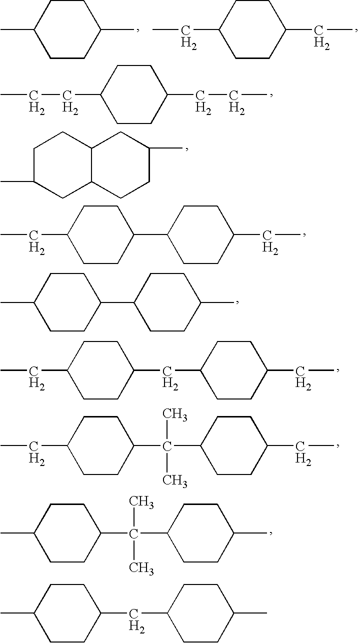

The preferred cycloaliphatic radical R is derived from the 1,4- cyclohexyl diacids and most preferably greater than 70 mol % thereof in the form of the trans isomer. The preferred cycloaliphatic radical is derived from the 1,4-cyclohexyl primary diols such as 1,4-cyclohexyl dimethanol, most preferably more than 70 mol % thereof in the form of the trans isomer.

Typically, in the hydrogenation, two isomers are obtained in which the carboxylic acid groups are in cis- or trans- positions. The cis- and trans- isomers can be separated by crystallization with or without a solvent, for example, n-heptane, or by distillation. The cis-isomer tends to blend better; however, the trans- isomer has higher melting and crystallization temperatures and may be preferred. Mixtures of the cis- and trans-isomers are useful herein as well. When the mixture of isomers or more than one diacid or diol is used, a copolyester or a mixture of two polyesters may be used as the present cycloaliphatic polyester resin.

A preferred cycloaliphatic polyester is poly(cyclohexane-1,4-dimethylene cyclohexane-1,4-dicarboxylate) also referred to as poly(1,4-cyclohexane-dimethanol 1,4-dicarboxylate) (PCCD) which has recurring units of formula V:

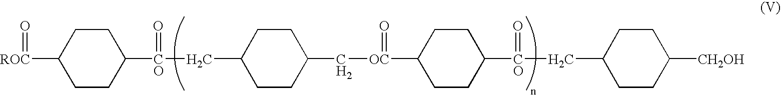

With reference to the previously set forth general formula, for PCCD, R₃ is derived from 1,4 cyclohexane dimethanol; and R₄ is a cyclohexane ring derived from cyclohexanedicarboxylate or a chemical equivalent thereof. The favored PCCD has a cis/trans formula. In one embodiment R is an alkyl from 1 to 6 carbon atoms or residual end groups derived from either monomer, and n is greater than about 70. The polyester is derived from the transesterification reaction of a starting DMCD and a starting CHDM. The trans-cis ratio of repeating units derived from DMCD is preferably greater than about 8 to 1, and the trans-cis ratio of repeating units derived from CHDM is preferable greater than about 1 to 1. The polyester resin typically a viscosity of about 2500 poise and a melting temperature greater than 216 C degrees Centigrade, and an acid number less than about 10, preferably less than about 6 meq/kg.

The linear PCCD polyester is prepared by the condensation reaction of CHDM and DMCD in the presence of a catalyst wherein the starting DMCD has a trans-cis ratio greater than the equilibrium trans-cis ratio. The resulting prepared PCCD polyester has a trans-cis ratio of repeating polymer units derived from the respective starting DMCD, which has a trans-cis ratio substantially equal to the respective starting trans-cis ratio for enhancing the crystallinity of the resulting PCCD.

The starting DMCD typically has a trans-cis ratio greater than about 6 to 1, preferably greater than 9 to 1, and even more preferably greater than 19 to 1. In the resulting PCCD, it is preferable that less than about 10 percent the starting trans DMCD, and more preferable that less than about 5 percent of the starting trans DMCD be converted to the cis isomer during the reaction of CHDM and DMCD to produce PCCD. The trans:cis ratio of the CHDM is preferable greater than 1 to 1, and more preferably greater than about 2 to 1.

The resulting linear PCCD polymer is characterized by the absence of branching. During the reaction process, branching may be induced by the addition of polyglycol and such branching agents as trimellitic acid or anhydride, trimesic acid, trimethyiolethane, trimethylolpropane, or a trimer acid. The use of such branching agents is not desirable according to the present invention.

Preferably the amount of catalyst present is less than about 200 ppm. Typically, catalyst may be present in a range from about 20 to about 300 ppm. The most preferred materials are blends where the polyester has both cycloaliphatic diacid and cycloaliphatic diol components specifically polycyclohexane dimethanol cyclohexyl dicarboxylate (PCCD).

In one embodiment the above polyesters with from about 1 to about 50% by weight, of units derived from polymeric aliphatic acids and/or polymeric aliphatic polyols to form copolyesters. The aliphatic polyols include glycols, such as poly(ethylene glycol) or poly(butylene glycol). In another embodiment suitable copolymeric polyester resins include, e.g., polyesteramide copolymers, cyclohexanedimethanol-terephthalic acid-isophthalic acid copolymers and cyclohexanedimethanol-terephthalic acid-ethylene glycol (“PCTG”) copolymers. The polyester component may be prepared by procedures well known to those skilled in this art, such as by condensation reactions. The condensation reaction may be facilitated by the use of a catalyst, with the choice of catalyst being determined by the nature of the reactants. The various catalysts for use herein are very well known in the art and are too numerous to mention individually herein. Generally, however, when an alkyl ester of the dicarboxylic acid compound is employed, an ester interchange type of catalyst is preferred, such as Ti(OC₄H₉)₆ in n-butanol in a suitable amount, typically about 50 ppm to about 200 ppm of titanium based upon the final product.

The preferred polyesters are preferably low molecular weight polyester polymers have an intrinsic viscosity (as measured in 60:40 solvent mixture of phenol/tetrachloroethane at 25° C.) ranging from about 0.1 to about 0.5 deciliters per gram. Polyesters branched or unbranched and generally will have a weight average molecular weight of from about 5,000 to about 30,000, preferably from about 8,000 to about 20,000 as measured by viscosity measurements in Phenol/tetrachloroethane (60:40, volume/volume ratio) solvent mixture. It is contemplated that the polyesters have various known end groups.

In one embodiment of the present invention the copolyesters are prepared by melt processes that are well known to those skilled in the art and consist of several steps. The first reaction step is generally done under a nitrogen sweep with efficient stirring and the reactants may be heated slowly or quickly. Appropriate reaction conditions for a variety of acid-glycol polymerizations are known in the art. Any polymerization temperature, which gives a clear melt under the addition conditions and affords a reasonable rate of polymerization without unwanted amount of side reaction and degradation may be used. In one embodiment the temperature of the reaction is between about 240° C. and about 350° C. In another embodiment the temperature is between about 260° C. and about 310° C. The reaction is maintained in this stage for 0.5 to 3 hours with the condensation reaction of amidation and esterification taking place. In one embodiment the reaction is then carried out under vacuum of about 0.1 Torr while the reaction occurs and copolyester of desired molecular weight is built. In one embodiment the copolyester is recovered in the last step by either cooling and isolating the polymer and grinding or by extruding the hot polymer melt, cooling and pelletizing.

In one embodiment the catalysts include, but are not limited to metal salts and chelates of Ti, Zn, Ge, Ga, Sn, Ca, Li and Sb. Other known catalysts may also be used for this step-growth polymerization. Examples of the esterification catalysts which may be employed in the above melt reaction process include titanium alkoxides. such as tetramethyl, tetraethyl, tetra(n-propyl), tetraisopropyl and tetrabutyl titanates; dialkyl tin compounds, such as di-(n-butyl) tin dilaurate. di-(n-butyl) tin oxide and di-(n-butyl) tin diacetate; and oxides. acetate salts and sulfate salts of metals, such as magnesium, calcium, germanium, zinc, antimony, etc. Conveniently titanium alkoxides are employed. The catalyst level is employed in an effective amount to enable the copolymer formation and is not critical and is dependent on the catalyst that is used. Generally the catalyst is used in concentration ranges of about 10 to about 500 ppm, preferably about 20 to about 300 ppm and most preferably about 30 to about 250 ppm.

The ratio of reactants in these polymerizations is important. In one embodiment of the present invention the amount of diol is maintained constant and the ratio of diester to esteramide of the present invention is varied. In one embodiment the amount of diol is 100 mole percent. The amount of diacid is in the range between about 70 mole percent and about 99 mole percent. In another embodiment the amount of diacid is in the range between about 75 mole percent and about 95 mole percent. In another embodiment the amount of esteramide that is added is between about 30 mole percent and about 1 mole percent. In an alternate embodiment the amount of esteramide is between about 5 mole percent and about 25 mole percent.

The reaction may be conducted optionally in presence of a solvent or in neat conditions without the solvent. The organic solvent used in the above process according to the invention should be capable of dissolving the ester amide, the esteramide copolymer resulting from the reactions between the ester amide, diol, and diacid to an extent of at least 0.01 g/per ml at 25° C. and should have a boiling point in the range of 140-290° C. at atmospheric pressure. Preferred examples of the solvent include but are not limited to amide solvents, in particular, N-methyl-2-pyrrolidone; N-acetyl-2-pyrrolidone; N,N′-dimethyl formamide; N,N′-dimethyl acetamide; N, N′-diethyl acetamide; N,N′-dimethyl propionic acid amide; N,N′-diethyl propionic acid amide; tetramethyl urea; tetraethyl urea; hexamethylphosphor triamide; N-methyl caprolactam and the like. Other solvents may also be employed, for example, methylene chloride, chloroform, 1,2-dichloroethane, tetrahydrofuran, diethyl ether, dioxane, benzene, toluene, chlorobenzene, o-dichlorobenzene and the like.

In one embodiment the glass transition temperatures (T_{g}) of the copolyesters that are substantially higher than the homopolyesters. The copolyesters of the present invention have a glass transition temperature in the range of between about 65° C. and about 130° C. In one embodiment of the present invention the glass transition temperature and the melting temperature is dependent on the amount of esteramide in the copolymer. In one embodiment the crystallinity of the copolymer decreases with increase in amount of esteramide while an increase in glass transition is observed. Preferably, the number average molecular weight of the esteramide copolymer ranges from about 5,000 to about 500,000. If the number average molecular weight is less than about 5,000, the copolymer product shows poor mechanical properties.

A component of the blend of the invention is an aromatic polycarbonate. The aromatic polycarbonate resins suitable for use in the present invention, methods of making polycarbonate resins and the use of polycarbonate resins in thermoplastic molding compounds are well known in the art, see, generally, U.S Pat. Nos. 3,169,121, 4,487,896 and 5,411,999, the respective disclosures of which are each incorporated herein by reference.

Polycarbonates useful in the invention comprise repeating units of the formula: 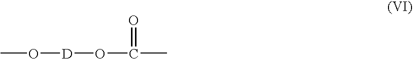
wherein R¹ is a divalent aromatic radical derived from a dihydroxyaromatic compound of the formula HO—D—OH, wherein D has the structure of formula: 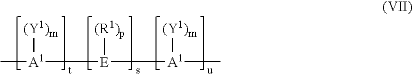
wherein A¹ represents an aromatic group including, but not limited to, phenylene, biphenylene, naphthylene, and the like. In some embodiments E may be an alkylene or alkylidene group including, but not limited to, methylene, ethylene, ethylidene, propylene, propylidene, isopropylidene, butylene, butylidene, isobutylidene, amylene, amylidene, isoamylidene, and the like. In other embodiments when E is an alkylene or alkylidene group, it may also consist of two or more alkylene or alkylidene groups connected by a moiety different from alkylene or alkylidene, including, but not limited to, an aromatic linkage; a tertiary nitrogen linkage; an ether linkage; a carbonyl linkage; a silicon-containing linkage, silane, siloxy; or a sulfur-containing linkage including, but not limited to, sulfide, sulfoxide, sulfone, and the like; or a phosphorus-containing linkage including, but not limited to, phosphinyl, phosphonyl, and the like. In other embodiments E may be a cycloaliphatic group including, but not limited to, cyclopentylidene, cyclohexylidene, 3,3,5-trimethylcyclohexylidene, methylcyclohexylidene, 2-[2.2.1]-bicycloheptylidene, neopentylidene, cyclopentadecylidene, cyclododecylidene, adamantylidene, and the like; a sulfur-containing linkage, including, but not limited to, sulfide, sulfoxide or sulfone; a phosphorus-containing linkage, including, but not limited to, phosphinyl or phosphonyl; an ether linkage; a carbonyl group; a tertiary nitrogen group; or a silicon-containing linkage including, but not limited to, silane or siloxy. R¹ independently at each occurrence comprises a monovalent hydrocarbon group including, but not limited to, alkenyl, allyl, alkyl, aryl, aralkyl, alkaryl, or cycloalkyl. In various embodiments a monovalent hydrocarbon group of R¹ may be halogen-substituted, particularly fluoro- or chloro-substituted, for example as in dichloroalkylidene, particularly gem-dichloroalkylidene. Y¹ independently at each occurrence may be an inorganic atom including, but not limited to, halogen (fluorine, bromine, chlorine, iodine); an inorganic group containing more than one inorganic atom including, but not limited to, nitro; an organic group including, but not limited to, a monovalent hydrocarbon group including, but not limited to, alkenyl, allyl, alkyl, aryl, aralkyl, alkaryl, or cycloalkyl, or an oxy group including, but not limited to, OR² wherein R² is a monovalent hydrocarbon group including, but not limited to, alkyl, aryl, aralkyl, alkaryl, or cycloalkyl; it being only necessary that Y¹ be inert to and unaffected by the reactants and reaction conditions used to prepare the polymer. In some particular embodiments Y¹ comprises a halo group or C₁-C₆ alkyl group. The letter “m” represents any integer from and including zero through the number of replaceable hydrogens on Al available for substitution; “p” represents an integer from and including zero through the number of replaceable hydrogens on E available for substitution; “t” represents an integer equal to at least one; “s” represents an integer equal to either zero or one; and “u” represents any integer including zero.

In dihydroxy-substituted aromatic hydrocarbons in which D is represented by formula (VII) above, when more than one Y¹ substituent is present, they may be the same or different. The same holds true for the R¹ substituent. Where “s” is zero in formula (VII) and “u” is not zero, the aromatic rings are directly joined by a covalent bond with no intervening alkylidene or other bridge. The positions of the hydroxyl groups and Y¹ on the aromatic nuclear residues A¹ can be varied in the ortho, meta, or para positions and the groupings can be in vicinal, asymmetrical or symmetrical relationship, where two or more ring carbon atoms of the hydrocarbon residue are substituted with Y¹ and hydroxyl groups. In some particular embodiments the parameters “t”, “s”, and “u” each have the value of one; both A¹ radicals are unsubstituted phenylene radicals; and E is an alkylidene group such as isopropylidene. In some particular embodiments both A¹ radicals are p-phenylene, although both may be o- or m-phenylene or one o- or m-phenylene and the other p-phenylene.

In some embodiments of dihydroxy-substituted aromatic hydrocarbons E may be an unsaturated alkylidene group. Suitable dillydroxy-substituted aromatic hydrocarbons of this type include those of the formula (VIII): 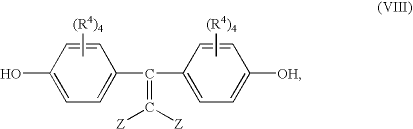
where independently each R⁴ is hydrogen, chlorine, bromine or a C₁₋₃₀ monovalent hydrocarbon or hydrocarbonoxy group, each Z is hydrogen, chlorine or bromine, subject to the provision that at least one Z is chlorine or bromine.

Suitable dihydroxy-substituted aromatic hydrocarbons also include those of the formula (IX): 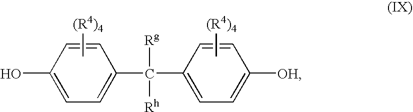
where independently each R4 is as defined hereinbefore, and independently Rg and Rh are hydrogen or a C1-30 hydrocarbon group.

In some embodiments of the present invention, dihydroxy-substituted aromatic hydrocarbons that may be used comprise those disclosed by name or formula (generic or specific) in U.S. Pat. Nos. 2,991,273, 2,999,835, 3,028,365, 3,148,172, 3,153,008, 3,271,367, 3,271,368, and 4,217,438. In other embodiments of the invention, dihydroxy-substituted aromatic hydrocarbons comprise bis(4-hydroxyphenyl)sulfide, bis(4-hydroxyphenyl) ether, bis(4-hydroxyphenyl)sulfone, bis(4-hydroxyphenyl)sulfoxide, 1,4-dihydroxybenzene, 4,4′-oxydiphenol, 2,2-bis(4-hydroxyphenyl)hexafluoropropane, 4,4′-(3,3,5-trimethylcyclohexylidene)diphenol; 4,4′-bis(3,5-dimethyl)diphenol, 1,1 -bis(4-hydroxy-3-methylphenyl)cyclohexane; 4,4-bis(4-hydroxyphenyl)heptane; 2,4′-dihydroxydiphenylmethane; bis(2-hydroxyphenyl)methane; bis(4-hydroxyphenyl)methane; bis(4-hydroxy-5-nitrophenyl)methane; bis(4-hydroxy-2,6-dimethyl-3-methoxyphenyl)methane; 1,1 -bis(4-hydroxyphenyl)ethane; 1,2-bis(4-hydroxyphenyl)ethane; 1,1 -bis(4-hydroxy-2- chlorophenyl)ethane; 2,2-bis(3-phenyl-4-hydroxyphenyl)propane; 2,2-bis(4-hydroxy-3-methylphenyl)propane; 2,2-bis(4-hydroxy-3-ethylphenyl)propane; 2,2-bis(4-hydroxy-3-isopropylphenyl)propane; 2,2-bis(4-hydroxy-3,5-dimethylphenyl)propane; 3,5,3′,5′-tetrachloro-4,4′-dihydroxyphenyl)propane; bis(4-hydroxyphenyl)cyclohexylmethane; 2,2-bis(4-hydroxyphenyl)-1-phenylpropane; 2,4′-dihydroxyphenyl sulfone; dihydroxy naphthalene; 2,6-dihydroxy naphthalene; hydroquinone; resorcinol; C1-3 alkyl-substituted resorcinols; methyl resorcinol, catechol, 1,4-dihydroxy-3-methylbenzene; 2,2-bis(4-hydroxyphenyl)butane; 2,2-bis(4-hydroxyphenyl)-2-methylbutane; 1,1-bis(4-hydroxyphenyl)cyclohexane; 4,4′-dihydroxydiphenyl; 2-(3-methyl-4-hydroxyphenyl-2-(4-hydroxyphenyl)propane; 2-(3,5-dimethyl-4-hydroxyphenyl)-2-(4- hydroxyphenyl)propane; 2-(3-methyl-4-hydroxyphenyl)-2-(3,5-dimethyl-4-hydroxyphenyl)propane; bis(3,5-dimethylphenyl-4-hydroxyphenyl)methane; 1,1-bis(3,5-dimethylphenyl-4-hydroxyphenyl)ethane; 2,2-bis(3,5-dimethylphenyl-4-hydroxyphenyl)propane; 2,4-bis(3,5-dimethylphenyl-4-hydroxyphenyl)-2-methylbutane; 3,3-bis(3,5-dimethylphenyl-4-hydroxyphenyl)pentane; 1,1 -bis(3,5-dimethylphenyl-4-hydroxyphenyl)cyclopentane; 1,1 -bis(3,5-dimethylphenyl-4-hydroxyphenyl)cyclohexane; bis(3,5-dimethyl-4-hydroxyphenyl) sulfoxide, bis(3,5-dimethyl-4-hydroxyphenyl) sulfone and bis(3,5-dimethylphenyl-4-hydroxyphenyl)sulfide. In a particular embodiment the dihydroxy-substituted aromatic hydrocarbon comprises bisphenol A.

In some embodiments of dihydroxy-substituted aromatic hydrocarbons when E is an alkylene or alkylidene group, said group may be part of one or more fused rings attached to one or more aromatic groups bearing one hydroxy substituent. Suitable dihydroxy-substituted aromatic hydrocarbons of this type include those containing indane structural units such as represented by the formula (X), which compound is 3-(4-hydroxyphenyl)-1,1,3-trimethylindan-5-ol, and by the formula (XI), which compound is 1-(4-hydroxyphenyl)-1,3,3-trimethylindan-5-ol:

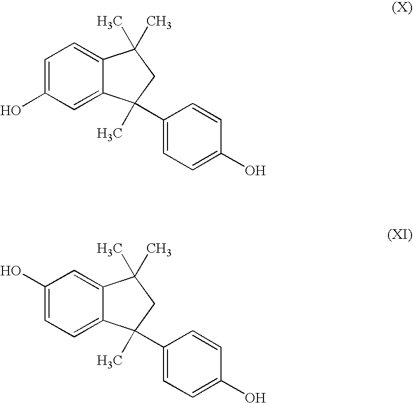

Also included among suitable dihydroxy-substituted aromatic hydrocarbons of the type comprising one or more alkylene or alkylidene groups as part of fused rings are the 2,2,2′,2′-tetrahydro-1,1′-spirobi[1H-indene]diols having formula (XII): 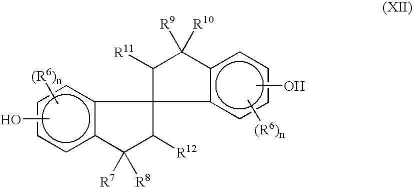
wherein each R6 is independently selected from monovalent hydrocarbon radicals and halogen radicals; each R7, R8, R9, and R10 is independently C1-6 alkyl; each R11 and R12 is independently H or C1-6 alkyl; and each n is independently selected from positive integers having a value of from 0 to 3 inclusive. In a particular embodiment the 2,2,2′,2′-tetrahydro-1,1′-spirobi[1H-indene]diol is 2,2,2′,2′-tetrahydro-3,3,3′,3′- tetramethyl-1,1′-spirobi[1H-indene]-6,6′-diol (sometimes known as “SBI”). Mixtures of alkali metal salts derived from mixtures of any of the foregoing dihydroxy-substituted aromatic hydrocarbons may also be employed.

The term “alkyl” as used in the various embodiments of the present invention is intended to designate both linear alkyl, branched alkyl, aralkyl, cycloalkyl, bicycloalkyl, tricycloalkyl and polycycloalkyl radicals containing carbon and hydrogen atoms, and optionally containing atoms in addition to carbon and hydrogen, for example atoms selected from Groups 15, 16 and 17 of the Periodic Table. The term “alkyl” also encompasses that alkyl portion of alkoxide groups. In various embodiments normal and branched alkyl radicals are those containing from 1 to about 32 carbon atoms, and include as illustrative non-limiting examples C1-C32 alkyl optionally substituted with one or more groups selected from C1-C32 alkyl, C3-C15 cycloalkyl or aryl; and C3-C15 cycloalkyl optionally substituted with one or more groups selected from C1-C32 alkyl. Some particular illustrative examples comprise methyl, ethyl, n-propyl, isopropyl, n-butyl, sec-butyl, tertiary-butyl, pentyl, neopentyl, hexyl, heptyl, octyl, nonyl, decyl, undecyl and dodecyl. Some illustrative non-limiting examples of cycloalkyl and bicycloalkyl radicals include cyclobutyl, cyclopentyl, cyclohexyl, methylcyclohexyl, cycloheptyl, bicycloheptyl and adamantyl. In various embodiments aralkyl radicals are those containing from 7 to about 14 carbon atoms; these include, but are not limited to, benzyl, phenylbutyl, phenylpropyl, and phenylethyl. In various embodiments aryl radicals used in the various embodiments of the present invention are those substituted or unsubstituted aryl radicals containing from 6 to 18 ring carbon atoms. Some illustrative non-limiting examples of these aryl radicals include C6-C15 aryl optionally substituted with one or more groups selected from C1-C32 alkyl, C3-C15 cycloalkyl or aryl. Some particular illustrative examples of aryl radicals comprise substituted or unsubstituted phenyl, biphenyl, toluyl and naphthyl.

Mixtures comprising two or more hydroxy-substituted hydrocarbons may also be employed. In some particular embodiments mixtures of at least two monohydroxy-substituted alkyl hydrocarbons, or mixtures of at least one monohydroxy-substituted alkyl hydrocarbon and at least one dihydroxy-substituted alkyl hydrocarbon, or mixtures of at least two dihydroxy-substituted alkyl hydrocarbons, or mixtures of at least two monohydroxy-substituted aromatic hydrocarbons, or mixtures of at least two dihydroxy-substituted aromatic hydrocarbons, or mixtures of at least one monohydroxy-substituted aromatic hydrocarbon and at least one dihydroxy-substituted aromatic hydrocarbon, or mixtures of at least one monohydroxy-substituted alkyl hydrocarbon and at least one dihydroxy-substituted aromatic hydrocarbon may be employed.

In yet another, the polycarbonate resin is a linear polycarbonate resin that is derived from bisphenol A and phosgene. In an alternative embodiment, the polycarbonate resin is a blend of two or more polycarbonate resins.

The aromatic polycarbonate may be prepared in the melt, in solution, or by interfacial polymerization techniques well known in the art. For example, the aromatic polycarbonates can be made by reacting bisphenol-A with phosgene, dibutyl carbonate or diphenyl carbonate. Such aromatic polycarbonates are also commercially available. In one embodiment, the aromatic polycarbonate resins are commercially available from General Electric Company, e.g., LEXAN™ bisphenol A-type polycarbonate resins.

The preferred polycarbonates are preferably high molecular weight aromatic carbonate polymers have an intrinsic viscosity (as measured in methylene chloride at 25° C.) ranging from about 0.30 to about 1.00. deciliters per gram. Polycarbonates may be branched or unbranched and generally will have a weight average molecular weight of from about 10,000 to about 200,000, preferably from about 20,000 to about 100,000 as measured by gel permeation chromatography. It is contemplated that the polycarbonate may have various known end groups.

The synthesis of polycarbonate polyester blends requires the presence of a catalyst to facilitate the formation of the blend. Generally, the transesterification catalyst (or mixture of catalysts) is added in very small amount (ppm level) during the melt mixing of polycarbonate and polyesters to promote the ester-carbonate exchange reactions. The catalyst employed are compounds of alkaline earth metal oxides such as magnesium oxides, calcium oxide, barium oxide and zinc oxide; alkali and alkaline earth metal salts; a Lewis catalyst such as tin or titanium compounds; a nitrogen-containing basic compound and the like. In one embodiment the catalysts present in an amount in the range of between about 5 to about 500 parts per million. However, the presence of excess catalyst leads to yellowing or color formation and the blends therefore become less transparent. Quenchers for example compounds like phosphoric acids, are typically added to the blends during the extrusion process to quench the excess catalyst and render the blends transparent. In one embodiment of the present invention additional catalyst or quencher are not added while the thermoplastic resin is being synthesized. In another embodiment of the present invention, the residual catalyst that is present in the polyester component is activated to enhance the ester-carbonate interchange reactions in reactive blending.

The composition of the present invention may include additional components which do not interfere with the previously mentioned desirable properties but enhance other favorable properties such as anti-oxidants, flame retardants, reinforcing materials, colorants, mold release agents, fillers, nucleating agents, UV light and heat stabilizers, lubricants, and the like. Additionally, additives such as antioxidants, minerals such as talc, clay, mica, barite, wollastonite and other stabilizers including but not limited to UV stabilizers, such as benzotriazole, supplemental reinforcing fillers such as flaked or milled glass, and the like, flame retardants, pigments or combinations thereof may be added to the compositions of the present invention.

Flame-retardant additives are desirably present in an amount at least sufficient to reduce the flammability of the polyester resin, preferably to a UL94 V-0 rating. The amount will vary with the nature of the resin and with the efficiency of the additive. In general, however, the amount of additive will be from 2 to 30 percent by weight based on the weight of resin. A preferred range will be from about 15 to 20 percent.

Typically halogenated aromatic flame-retardants include tetrabromobisphenol A polycarbonate oligomer, polybromophenyl ether, brominated polystyrene, brominated BPA polyepoxide, brominated imides, brominated polycarbonate, poly (haloaryl acrylate), poly (haloaryl methacrylate), or mixtures thereof. Examples of other suitable flame retardants are brominated polystyrenes such as polydibromostyrene and polytribromostyrene, decabromobiphenyl ethane, tetrabromobiphenyl, brominated alpha, omega -alkylene-bis-phthalimides, e.g. N,N′-ethylene-bis-tetrabromophthalimide, oligomeric brominated carbonates, especially carbonates derived from tetrabromobisphenol A, which, if desired, are end-capped with phenoxy radicals, or with brominated phenoxy radicals, or brominated epoxy resins.

The flame-retardants are typically used with a synergist, particularly inorganic antimony compounds. Such compounds are widely available or can be made in known ways. Typical, inorganic synergist compounds include Sb₂O₅, SbS₃, sodium antimonate and the like. Especially preferred is antimony trioxide (Sb₂O₃). Synergists such as antimony oxides, are typically used at about 0.5 to 15 by weight based on the weight percent of resin in the final composition. Also, the final composition may contain polytetrafluoroethylene (PTFE) type resins or copolymers used to reduce dripping in flame retardant thermoplastics.

Other additional ingredients may include antioxidants, and UV absorbers, and other stabilizers. Antioxidants include i) alkylated monophenols, for example: 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(alpha-methylcyclohexyl)-4,6 dimethylphenol, 2,6-di-octadecyl-4-methylphenol, 2,4,6,-tricyclohexyphenol, 2,6-di-tert-butyl-4-methoxymethylphenol; ii) alkylated hydroquinones, for example, 2,6-di-tert-butyl-4-methoxyphenol, 2,5-di-tert-butyl-hydroquinone, 2,5-di-tert-amyl-hydroquinone, 2,6-diphenyl-4octadecyloxyphenol; iii) hydroxylated thiodiphenyl ethers; iv) alkylidene-bisphenols; v) benzyl compounds, for example, 1,3,5-tris-(3,5-di-tert-butyl-4-hydroxybenzyl)-2,4,6-trimethylbenzene; vi) acylaminophenols, for example, 4-hydroxy-lauric acid anilide; vii) esters of beta-(3,5-di-tert-butyl-4-hydroxyphenol)-propionic acid with monohydric or polyhydric alcohols; viii) esters of beta-(5-tert-butyl-4-hydroxy-3-methylphenyl)-propionic acid with monohydric or polyhydric alcohols; vii) esters of beta-(5-tert-butyl-4-hydroxy-3-methylphenyl) propionic acid with mono-or polyhydric alcohols, e.g., with methanol, diethylene glycol, octadecanol, triethylene glycol, 1,6-hexanediol, pentaerythritol, neopentyl glycol, tris(hydroxyethyl) isocyanurate, thiodiethylene glycol, N,N-bis(hydroxyethyl) oxalic acid diamide. Typical, UV absorbers and light stabilizers include i) 2-(2′-hydroxyphenyl)-benzotriazoles, for example, the 5′methyl-,3′5′-di-tert-butyl-,5′-tert-butyl-,5′(1,1,3,3-tetramethylbutyl)-,5-chloro-3′,5′-di-tert-butyl-,5-chloro-3′tert-butyl-5′methyl-,3′sec-butyl-5′tert-butyl-,4′-octoxy,3′,5′-ditert-amyl-3′,5′-bis-(alpha, alpha-dimethylbenzyl)-derivatives; ii) 2.2 2-Hydroxy-benzophenones, for example, the 4-hydroxy-4-methoxy-, 4-octoxy,4-decloxy-,4-dodecyloxy-,4-benzyloxy,4,2′,4′-trihydroxy-and 2′hydroxy-4,4′-dimethoxy derivative, and iii) esters of substituted and unsubstituted benzoic acids for example, phenyl salicylate, 4-tert-butylphenyl-salicilate, octylphenyl salicylate, dibenzoylresorcinol, bis-(4-tert-butylbenzoyl)-resorcinol, benzoylresorcinol, 2,4-di-tert-butyl-phenyl-3,5-di-tert-butyl-4-hydroxybenzoate and hexadecyl-3,5-di-tert-butyl-4- hydroxybenzoate. Phosphites and phosphonites stabilizers, for example, include triphenyl phosphite, diphenylalkyl phosphites, phenyldialkyl phosphites, tris(nonyl-phenyl)phosphite, trilauryl phosphite, trioctadecyl phosphite, distearyl pentaerythritol diphosphite, tris(2,4-di-tert-butylphenyl)phosphite, diisodecyl pentaerythritol diphosphite, bis(2,4-di-tert-butylphenyl)pentaerythritol diphosphite tristearyl sorbitol triphosphite, and tetrakis(2,4-di-tert-butylphenyl)4,4′-biphenylene diphosphonite.

Dyes or pigments may be used to give a background coloration. Dyes are typically organic materials that are soluble in the resin matrix while pigments may be organic complexes or even inorganic compounds or complexes which are typically insoluble in the resin matrix. These organic dyes and pigments include the following classes and examples: furnace carbon black, titanium oxide, phthalocyanine blues or greens, anthraquinone dyes, scarlet 3b Lake, azo compounds and acid azo pigments, quinacridones, chromophthalocyanine pyrrols, halogenated phthalocyanines, quinolines, heterocyclic dyes, perinone dyes, anthracenedione dyes, thioxanthene dyes, parazolone dyes, polymethine pigments and others.

The range of composition of the thermoplastic resin of the present invention is from about 10 to 90 weight percent of the polycarbonate component, 90 to about 10 percent by weight of the copolyester component. In one embodiment, the composition comprises about 25-75 weight percent polycarbonate and 75-25 weight percent of the copolyester component.

The method of blending can be carried out by conventional techniques. The production of the compositions may utilize any of the blending operations known for the blending of thermoplastics, for example blending in a kneading machine such as a Banbury mixer or an extruder. To prepare the resin composition, the components may be mixed by any known methods. Typically, there are two distinct mixing steps: a premixing step and a melt-mixing step. In the premixing step, the dry ingredients are mixed together. The premixing step is typically performed using a tumbler mixer or ribbon blender. However, if desired, the premix may be manufactured using a high shear mixer such as a Henschel mixer or similar high intensity device. The premixing step is typically followed by a melt mixing step in which the premix is melted and mixed again as a melt. Alternatively, the premixing step may be omitted, and raw materials may be added directly into the feed section of a melt mixing device, preferably via multiple feeding systems. In the melt mixing step, the ingredients are typically melt kneaded in a single screw or twin screw extruder, a Banbury mixer, a two roll mill, or similar device. In one embodiment the blend synthesized by melt mixing process the pre mixing is carried out at a temperature range of between about 200° C. to about 300° C. The heating or melt mixing is typically carried out at a temperature range of about 210° C. to about 280° C.

In one embodiment of the present invention the thermoplastic composition could be prepared by solution method. The solution method involves dissolving all the ingredients in a common solvent (or) a mixture of solvents and either precipitation in a non-solvent or evaporating the solvent either at room temperature or a higher temperature of at least about 50° C. to about 80° C. In one embodiment, the polycarbonates and the polyester can be mixed with a relatively volatile solvent, preferably an organic solvent, which is substantially inert towards the polymer, and will not attack and adversely affect the polymer. Some suitable organic solvents include ethylene, glycol diacetate, butoxyethanol, methoxypropanol, the lower alkanols, chloroform, acetone, methylene chloride, carbon tetrachloride, tetrahydrofuran, and the like. In one embodiment of the present invention the non-solvent is at least one selected from the group consisting of mono alcohols such as ethanol, methanol, isopropanol, butanols and lower alcohols with C1 to about C12 carbon atoms. In one embodiment the solvent is chloroform.

The glass transition temperature of the preferred blend is from about 70° C. to about 160° C., more preferably from 75° C. to about 155° C.

The composition of the present invention can be molded into useful articles by a variety of means by many different processes to provide useful molded products such as injection, extrusion, rotation, foam molding calendar molding and blow molding and thermoforming, compaction, melt spinning form articles. The thermoplastic composition of the present invention has additional properties of good mechanical properties, color stability, oxidation resistance, good flame retardancy, good processability, i.e. short molding cycle times, thermal properties. The articles made from the composition of the present invention may be used widely for both opaque and transparent applications. Non limiting examples of the various articles that could be made from the thermoplastic composition of the present invention include house ware objects such as food containers and bowls, home appliances, as well as films, electrical connectors, electrical devices, computers, building and construction, outdoor equipment, trucks and automobiles.

### EXAMPLES

Without further elaboration, it is believed that one skilled in the art can, using the description herein, utilize the present invention to its fullest extent. The following examples are included to provide additional guidance to those skilled in the art in practicing the claimed invention. The examples provided are merely representative of the work that contributes to the teaching of the present application. While only certain features of the invention have been illustrated and described herein, many modifications and changes will occur to those skilled in the art. Accordingly, these examples are not intended to limit the invention, as defined in the appended claims, in any manner.

In the following examples values for glass transition temperatures (Tg) were determined by differential scanning calorimetry (DSC) at a heating rate of 20° C. per minute. Weight average molecular weights were measured by gel permeation chromatography (GPC) versus polystyrene standards using chloroform as solvent. The GPC column was a Mixed-C column with dimensions 300 millimeters (mm)×7.5 mm available from Polymer Laboratories.

Preparation of Esteramides

### EXAMPLES 1-5

A 250 ml capacity three-necked round bottom flask was equipped with a magnetic stirring bar. A dropping funnel and a reflux condenser were connected to the flask. A nitrogen in let was connected to the flask. The flask is charged with one equivalent of dicarboxylic acid, toluene and dimethylformamide (DMF) (1 ml). To this mixture, three equivalents of thionylchloride (SOCl₂) was added drop wise at room temperature. The resulting mixture was then heated to reflux for about 90 minutes. Excess of thionylchloride and toluene were removed by distillation under water aspirator vacuum. The pale yellow color dicarbonyl dichloride formed was used dissolved in toluene. A 250 ml capacity two-necked flask was fitted with a dropping funnel and nitrogen in let. Two equivalents of p-amino ethyl benzoate was placed in the flask and 2.5 equivalents of triethyl ammonia (TEA) in toluene was added to the flask through the dropping funnel. The solution of dicarbonyl dichloride in toluene was added drop wise at room temperature over a period of 30 minutes. The mixture was stirred continuously for about 5h. The reaction mixture was then filtered with suction, washed with about 75 ml of toluene and the esteramide formed was collected in high yields and purity. Optionally further purification of the product was carried out by recrystallization using solvents as listed in Table 1 to obtain ester-amide in high yield and purity. NMR and HPLC techniques confirmed the structure and purity of ester-amides. Table 2 gives the various formulations for the esteramides.

TABLE 1

| | | | p-Amino- | | Yield | | |
|---|---|---|---|---|---|---|---|
| | | | ethyl- | | of | | |
| | Dicarboxylic acid | SOCl₂ | benzoate | TEA | esteramide | Purity | Non- |
| | (grams) | (grams) | (grams) | (grams) | (%) | (%) | solvents |
| Ex 1 | DMCD-mono acid | 19.6 | 38.16 | 26.7 | 66.8 | 98 | DMF/ |
| | (20.4) | | | | | | H₂O |
| Ex 2 | 1,4-CHDM (50) | 103.5 | 100.6 | 70.4 | 70.6 | 96 | CHCl₃/ |
| | | | | | | | Toluene |
| Ex 3 | Decalindicarboxylic | 78.5 | 45.8 | Pyridi-ne | 80 | 98 | DMF |
| | acid (30) | | | 26.1 | | | |
| Ex 4 | Tetralin | 24.27 | 23.59 | 16.5 | 95 | 99.5 | DMF/ |
| | dicarboxylic acid | | | | | | H₂O |
| | (15) | | | | | | |

DMCD = dimethyl-1,4-cyclohexane dicarboxylate;
CHDM = 1,4-cyclohexanediacid

Preparation of Copolymers

### EXAMPLES 6-16

The monomers 1,4-cyclohexane dimethanol (0.07 moles) and dimethyl 1,4-cyclohexanedicarboxylate (0.665 to 0.056 moles) were taken in the reactor provided with a side arm and a mechanical stirrer. This side arm also used to purge nitrogen gas and also for applying vacuum. The monomers were heated to melt at 250° C. under nitrogen with constant stirring (100 rpm). The reactor was evacuated and purged with Nitrogen for three times to remove the traces of oxygen. About 400

ppm of Ti(isopropoxide)₄ was added and the methanol generated was distilled through the side arm. The melt was heated to 280° C. and stirred for 1 hour under nitrogen. The reactor was evacuated by applying the vacuum gradually and in stepwise at 100, 50, 25 10 mbar at 280° C. Very high vacuum of 0.5 to 0.1 mbar was further applied and the polymerization was allowed to proceed for 45 to 60 minutes. The polymers were collected by breaking the nipple in the bottom of the reactor. The copolymers having various amount of amide linkages were prepared by varying the amount of ester amide monomers (given in Examples 1-5) as shown in Table 2.

TABLE 2

| | Esteramide | Feed ratio | Intrinsic | Mₙ^{d} | M_{w}^{d} | | T_{g} of |
|---|---|---|---|---|---|---|---|
| | monomer^{a} | (mole %) | viscosity | (g/mol) | (g/mol) | M_{w}/Mₙ | copolyester |
| CEx1 | — | — | 0.83 | 31600 | 60000 | 1.9 | 65 |
| Ex 6 | EAI | 5 | 0.51 | 14300 | 31400 | 2.2 | 71 |
| Ex 7 | EAI | 10 | 0.47 | 13900 | 29900 | 2.2 | 74 |
| Ex 8 | EAI | 20 | 0.73 | 17500 | 43400 | 2.5 | 95 |
| Ex 9 | EAII | 5 | 0.62 | 19000 | 35200 | 1.9 | 80 |
| Ex 10 | EAII | 10 | 0.62 | 18000 | 32900 | 1.8 | 86 |
| Ex 11 | EAII | 20 | 0.59 | 12400 | 22400 | 1.8 | 102 |
| Ex 12 | EAIII | 10 | 0.64 | 20600 | 40300 | 1.9 | 98 |
| Ex 13 | EAIII | 20 | 0.51 | 12700 | 22400 | 1.8 | 120 |
| Ex 14 | EAIV | 10 | 0.69 | 20900 | 39800 | 1.9 | 95 |
| Ex 15 | EAIV | 20 | 0.56 | 11400 | 19400 | 1.7 | 114 |
| Ex 16 | EAV | 5 | 0.51 | 18200 | 38400 | 2.1 | 74 |

^{a}= The esteramide monomer structures EAI to EAV are shown in Scheme-1;
b = The amount of esteramide monomer is used;
c = Intrinsic viscosity is measured in phenol/tetrachloroethane (2:3 v/v) at 25° C.;
^{d}= The molecular weights are determined by GPC in chloroform at 25° C. using polystyrene standards, CEx1 = PCCD polymer

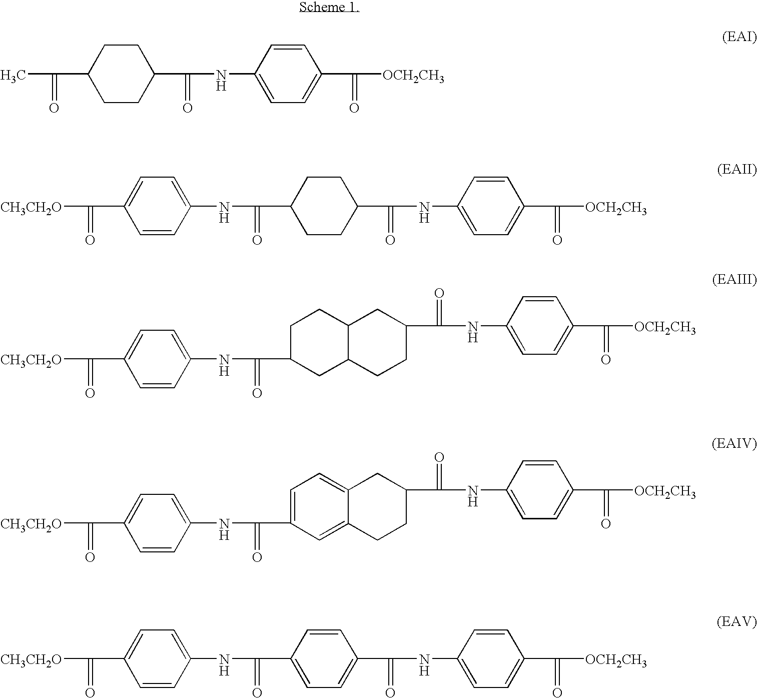 TABLE 3

| | T_{g}^{a} (° C.) | T_{c}^{a} (° C.) | ΔH_{c}^{a} J/g | Tₘ (° C.) | ΔHₘ (J/g) | T_{c}^{b} (° C.) | ΔH_{c}^{b} (J/g) |
|---|---|---|---|---|---|---|---|
| CEx1 | 65 | 107 | 7.5 | 225 | 26.7 | 150 | 11.9 |
| Ex 6 | 71 | 123 | 6.2 | 220 | 26.4 | 155 | 28.2 |
| Ex 7 | 74 | 127 | 8.7 | 218 | 25.8 | 139 | 12.1 |
| Ex 9 | 80 | 133 | 14.5 | 220 | 26.1 | 139 | 6.1 |
| Ex 10 | 86 | 159 | 20.8 | 212 | 19.9 | — | — |
| Ex 14 | 95 | 157 | 18.5 | 214 | 18.5 | — | — |
| Ex 16 | 74 | 128 | 3.2 | 212 | 23.3 | 131 | 16.4 |

^{a}= Residual crystallization while heating from the amorphous state
^{b}= Cooled crystallization while cooling from the molten state

It can been seen from the results of Table 3 that the higher the proportion of esteramide in the copolymer, the copolymer becomes less crystalline and an increase in amorphous nature is noticed. The 5 and 10 mole % incorporation of the esteramide is found to increase the residual crystallization temperature (T_{c}, heating cycle) and also melt crystallization temperature (Tₘ, cooling cycle). The amide linkage increases the T_{g} of the copolyesters and also induces more ordering.

Preparation of Blends:

In the examples, blends were made with 75 weight percent of polycarbonate available from General Electric Company as Lexan® polycarbonate resin blended with the high heat copolyester. The blends of copolyesters with polycarbonate were obtained by solvent cast method. In this method the know amounts of copolyesters and polycarbonate were dissolved in chloroform solvent (50 ml) to form a homogeneous solution. The solution allowed to evaporate at room temperature. The films were dried in vacuum at moderate temperatures of about 50-60° C. for about 12 hours to ensure that all the solvent had evaporated. The glass transition temperature (Tg) of the blends prepared was recorded. The data is given in Table 4. The blends have a glass transition temperature in the range of about 85° C. to about 145° C. depending upon the composition of the blend with different copolyesters.

TABLE 4

| | | Blends of Polyester | | | |
|---|---|---|---|---|---|
| | | modified by Esteramides | | | |
| | | with PC 105 | | | |
| | | % PE | % PC 105 | Tg of Blend | Tm of Blend |
| Polycarbonate | Ex10 | 25 | 75 | 136.5 | 240.6 |
| Polycarbonate | Ex10 | 50 | 50 | 92.9, 134.7 | 206.4, 236.8 |
| Polycarbonate | Ex11 | 25 | 75 | 110.9, 142.6 | 230.1 |
| Polycarbonate | Ex11 | 50 | 50 | 107.5, 137.4 | — |
| Polycarbonate | Ex16 | 25 | 75 | 119.1, 136.8 | 207.5, 232.1 |
| Polycarbonate | Ex16 | 50 | 50 | 85.2, 122.7 | 207.6, 231.3 |
| Polycarbonate | Ex14 | 25 | 75 | 144.9 | 232.4 |
| Polycarbonate | Ex14 | 50 | 50 | 98.1, 134.9 | 206.7, 229.4 |
| Polycarbonate | Ex15 | 25 | 75 | 115.5 | 237.2 |
| Polycarbonate | Ex15 | 50 | 50 | 93.5 | — |
| Polycarbonate | Ex13 | 25 | 75 | 143.1 | 229.3 |
| Polycarbonate | Ex13 | 50 | 50 | 120.1 | 236.6 |

While the invention has been illustrated and described in typical embodiments, it is not intended to be limited to the details shown, since various modifications and substitutions can be made without departing in any way from the spirit of the present invention. As such, further modifications and equivalents of the invention herein disclosed may occur to persons skilled in the art using no more than routine experimentation, and all such modifications and equivalents are believed to be within the spirit and scope of the invention as defined by the following claims. All Patents and published articles cited herein are incorporated herein by reference.

1. An ester amide composition of the formula:
Y—R—X;
wherein R is independently selected from the group consisting of a substituted or unsubstituted alkenyl, allyl, alkyl, substituted aryl, aralkyl, alkaryl, or cycloalkyl;
X is of the formula: 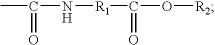
wherein R₁ and R₂ are independently selected from the group consisting of a substituted and unsubstituted alkenyl, allyl, alkyl, aryl, aralkyl, alkaryl, or cycloalkyl groups;
Y is independently selected from a group consisting of said X, COOR₃ group wherein R₃ independently selected from the group consisting of a substituted and unsubstituted alkenyl, allyl, alkyl, aryl, aralkyl, alkaryl, or cycloalkyl groups.

2. A method of making an ester amide composition of the formula:
Y—R—X;
wherein R is independently selected from the group consisting of a substituted or unsubstituted alkenyl, allyl, alkyl, aryl, aralkyl, alkaryl, or cycloalkyl;
X is of the formula: 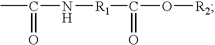
wherein R₁ and R₂ are independently selected from the group consisting of a substituted and unsubstituted alkenyl, allyl, alkyl, aryl, aralkyl, alkaryl, or cycloalkyl groups;
Y is independently selected from a group consisting of said X, COOR₃ group wherein R₃ independently selected from the group consisting of a substituted and unsubstituted alkenyl, allyl, alkyl, aryl, aralkyl, alkaryl, or cycloalkyl groups; said method comprising:
a. heating a diester or a diacid with a chlorinating agent and a catalyst to form a first mixture;
b. reacting said first mixture with an alkylaminoarylate and a second catalyst to form said ester amide.

3. The process of claim 2, wherein said diester is at least one selected from the group consisting of formula: 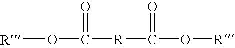
wherein R is independently selected from the group consisting of a substituted or unsubstituted alkenyl, allyl, alkyl, substituted aryl, aralkyl, alkaryl, or cycloalkyl;
R′″ is independently at least one selected from the group consisting of hydrogen, substituted or unsubstituted alkyl, substituted or unsubstituted aryl groups.
The process of claim 3, wherein said R′″ is independently at least one selected from the group consisting of hydrogen, substituted or unsubstituted alkyl groups containing about C1 to C15 carbon atoms.

4. The process of claim 2, wherein said chlorinating agent is at least one selected from the group consisting of phosphorous tirchloride, phosphorous pentachloride, antimony chlorides, phosphorous oxy chloride, sulphuryl chloride, thionyl chloride, alkali and alkaline salts of hypochlorites, carbon tetrachloride, chloroform, salts of dichlorocyanurate, salts of trichlorocyanurate and mixtures thereof.

5. The process of claim 2, wherein said alkylaminoarylate is alkylaminobenzoate.

6. The process of claim 2, wherein said catalyst is at least one selected from the group consisting of nickel, palladium, rhodium catalyst , charcoal.

7. The process of claim 2, wherein said second catalyst is at least one selected from the group consisting of trialkyl ammonia, wherein the alkyl group is at least one selected from the group consisting of methyl, ethyl, propyl, isopropyl, butyl, isobutyl triethyl.

8. The process of claim 2, wherein said heating is carried out at a temperature in the range of between about 25° C. and about 90° C.

9. A copolymer composition comprising: structural units derived from a substituted or unsubstituted diacid, a substituted or unsubstituted diol and an ester amide, wherein said ester amide comprises composition of the formula:
Y—R—X;
wherein R is independently selected from the group consisting of a substituted or unsubstituted alkenyl, allyl, alkyl, aryl, aralkyl, alkaryl, or cycloalkyl;
X is of the formula: 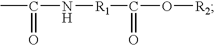
wherein R₁ and R₂ are independently selected from the group consisting of a substituted and unsubstituted alkenyl, allyl, alkyl, aryl, aralkyl, alkaryl, or cycloalkyl groups;
Y is independently selected from a group consisting of said X, COOR₃ group wherein R₃ independently selected from the group consisting of a substituted and unsubstituted alkenyl, allyl, alkyl, aryl, aralkyl, alkaryl, or cycloalkyl groups.

10. The composition of claim 9, wherein said diol is at least one selected from the group consisting of straight chain, branched, or cycloaliphatic alkane diols containing about 2 to 20 carbon atoms.

11. The composition of claim 9, wherein said diol is at least one selected from the group consisting of ethylene glycol; propylene glycol, pentane diol; dipropylene glycol; 2-methyl-1,5-pentane diol; 1,6-hexane diol; dimethanol decalin, dimethanol bicyclo octane; 1,4-cyclohexane dimethanol and particularly its cis- and trans-isomers; triethylene glycol; 1,10-decane diol; and mixtures thereof.

12. The composition of claim 9, wherein said diacid is at least one selected from the group consisting of linear acids, cycloaliphatic acids, bicyclo aliphatic acids, decahydro naphthalene dicarboxylic acids, norbomene dicarboxylic acids, bicyclo octane dicarboxylic acids, 1,4-cyclohexanedicarboxylic acid, adipic acid, azelaic acid, dicarboxyl dodecanoic acid, and succinic acid, dialkyl esters, diaryl esters, anhydrides, salts, acid chlorides, acid bromides, and mixtures thereof.

13. The composition of claim 9, wherein said diacid is at least one selected from the group consisting of 1,4-cyclohexanedicarboxylic acid, dialkyl esters of 1,4-cyclohexanedicarboxylic acid and mixtures thereof.

14. The composition of claim 9, wherein said diacid is present in a range of between about 99 mole percent and about 70 mole percent.

15. The composition of claim 9, wherein said esteramide is present in a range of between about 1 mole percent and about 30 mole percent.

16. The composition of claim 9, wherein said esteramide is present in range of between about 5 mole percent and about 25 mole percent.

17. The composition of claim 9, wherein said copolymer has molecular weight in the range between about 5000 to about 500,000.

18. The composition of claim 9, wherein said composition has a glass transition temperature of between about 65° C. and about 130° C.

19. A process to prepare a copolymer composition comprising: structural units derived from a substituted or unsubstituted diacid, a substituted or unsubstituted diol and an ester amide, wherein said ester amide comprises composition of the formula:
Y—R—X;
wherein R is independently selected from the group consisting of a substituted or unsubstituted alkenyl, allyl, alkyl, aryl, aralkyl, alkaryl, or cycloalkyl;
X is of the formula: 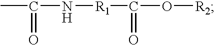
wherein R₁ and R₂ are independently selected from the group consisting of a substituted and unsubstituted alkenyl, allyl, alkyl, aryl, aralkyl, alkaryl, or cycloalkyl groups;
Y is independently selected from a group consisting of said X, COOR3 group wherein R3 independently selected from the group consisting of a substituted and unsubstituted alkenyl, allyl, alkyl, aryl, aralkyl, alkaryl, or cycloalkyl groups; and wherein said process comprises
a. mixing said diacid, diol and ester amide to form a first mixture;
b. heating said first mixture in presence of a catalyst to form said copolymer.

20. The process of claim 19, wherein said diol is at least one selected from the group consisting of ethylene glycol; propylene glycol, pentane diol; dipropylene glycol; 2-methyl-1,5-pentane diol; 1,6-hexane diol; dimethanol decalin, dimethanol bicyclo octane; 1,4-cyclohexane dimethanol and particularly its cis- and trans-isomers; triethylene glycol; 1,10-decane diol; and mixtures thereof.

21. The process of claim 19, wherein said diacid is at least one selected from the group consisting of linear acids, cycloaliphatic acids, bicyclo aliphatic acids, decahydro naphthalene dicarboxylic acids, norbornene dicarboxylic acids, bicyclo octane dicarboxylic acids, 1,4-cyclohexanedicarboxylic acid, adipic acid, azelaic acid, dicarboxyl dodecanoic acid, and succinic acid, dialkyl esters, diaryl esters, anhydrides, salts, acid chlorides, acid bromides, and mixtures thereof.

22. The process of claim 19, wherein said catalyst is at least one selected from the group consisting of metal salts and chelates of tin, zinc, germanium, gallium, antinomy, calcium, lithium, titanium and mixtures thereof.

23. The process of claim 19, wherein said catalyst is at least one selected from the group consisting of titanium alkoxides dialkyl tin compounds, diacetate and oxides salts of magnesium, diacetate and oxides salts of calcium, diacetate and oxides salts of germanium, diacetate and oxides salts of zinc, diacetate and oxides salts of antimony.

24. The process of claim 19, wherein said catalyst is present in a range of between about 10 and about 500 parts per million.

25. The process of claim 19, wherein said heating is carried out at a temperature between about 150° C. and about 280° C.

26. The process of claim 19, wherein said mixing is carried out in presence of a solvent.

27. The process of claim 19, wherein said solvent is at least one selected from the group consisting of amide solvents, methylene chloride, chloroform, dichlororethane, tetrahydrofuran, diethylether, dioxane, benezene, toluene, dochlorobenzene, chlorobenzene and mixtures thereof.

28. A thermoplastic resin composition comprising: structural units derived from a substituted or unsubstituted polycarbonate and a copolymer composition comprising: structural units derived from a substituted or unsubstituted diacid, a substituted or unsubstituted diol and an ester amide, wherein said ester amide comprises composition of the formula:
Y—R—X;
wherein R is independently selected from the group consisting of a substituted or unsubstituted alkenyl, allyl, alkyl, aryl, aralkyl, alkaryl, or cycloalkyl;
X is of the formula: 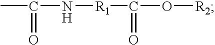
wherein R₁ and R₂ are independently selected from the group consisting of a substituted and unsubstituted alkenyl, allyl, alkyl, aryl, aralkyl, alkaryl, or cycloalkyl groups;
Y is independently selected from a group consisting of said X, COOR₃ group wherein R₃ independently selected from the group consisting of a substituted and unsubstituted alkenyl, allyl, alkyl, aryl, aralkyl, alkaryl, or cycloalkyl groups.

29. The composition of claim 28, wherein said polycarbonate comprises repeating units of the formula: 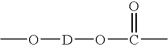
wherein R¹ is a divalent aromatic radical derived from a dihydroxyaromatic compound of the formula HO—D—OH, wherein D has the structure of formula: 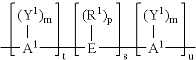
wherein A¹ represents an aromatic group; E comprises a sulfur-containing linkage, sulfide, sulfoxide, sulfone; a phosphorus-containing linkage, phosphinyl, phosphonyl; an ether linkage; a carbonyl group; a tertiary nitrogen group; a silicon-containing linkage; silane; siloxy; a cycloaliphatic group; cyclopentylidene, cyclohexylidene, 3,3,5-trimethylcyclohexylidene, methylcyclohexylidene, 2-[2.2.1]-bicycloheptylidene, neopentylidene, cyclopentadecylidene, cyclododecylidene, adamantylidene; an alkylene or alkylidene group, which group may optionally be part of one or more fused rings attached to one or more aromatic groups bearing one hydroxy substituent; an unsaturated alkylidene group; or two or more alkylene or alkylidene groups connected by a moiety different from alkylene or alkylidene and selected from the group consisting of an aromatic linkage, a tertiary nitrogen linkage; an ether linkage; a carbonyl linkage; a silicon-containing linkage, silane, siloxy; a sulfur-containing linkage, sulfide, sulfoxide, sulfone; a phosphorus-containing linkage, phosphinyl, and phosphonyl;
R¹ independently at each occurrence comprises a mono-valent hydrocarbon group, alkenyl, allyl, alkyl, aryl, aralkyl, alkaryl, or cycloalkyl;
Y¹ independently at each occurrence is selected from the group consisting of an inorganic atom, a halogen; an inorganic group, a nitro group; an organic group, a monovalent hydrocarbon group, alkenyl, allyl, alkyl, aryl, aralkyl, alkaryl, cycloalkyl, and an alkoxy group;
the letter “m” represents any integer from and including zero through the number of replaceable hydrogens on A¹ available for substitution;
the letter “p” represents an integer from and including zero through the number of replaceable hydrogens on E available for substitution;
the letter “t” represents an integer equal to at least one;
the letter “s” represents an integer equal to either zero or one; and
“u” represents any integer including zero.

30. The composition of claim 28, wherein the dihydroxyaromatic compound from which D is derived is bisphenol A.

31. The composition of claim 28, wherein said diol is at least one selected from the group consisting of straight chain, branched, or cycloaliphatic alkane diols containing about 2 to 20 carbon.

32. The composition of claim 28, wherein said diol is atoms ethylene glycol; propylene glycol, pentane diol; dipropylene glycol; 2-methyl-1,5-pentane diol; 1,6-hexane diol; dimethanol decalin, dimethanol bicyclo octane; 1,4-cyclohexane dimethanol and particularly its cis- and trans-isomers; triethylene glycol; 1,10-decane diol; and mixtures thereof.

33. The composition of claim 28, wherein said diacid is at least one selected from the group consisting of linear acids, cycloaliphatic acids, bicyclo aliphatic acids, decahydro naphthalene dicarboxylic acids, norbomene dicarboxylic acids, bicyclo octane dicarboxylic acids, 1,4-cyclohexanedicarboxylic acid, adipic acid, azelaic acid, dicarboxyl dodecanoic acid, and succinic acid, dialkyl esters, diaryl esters, anhydrides, salts, acid chlorides, acid bromides, and mixtures thereof.

34. The composition of claim 28, wherein said diacid is 1,4-cyclohexanedicarboxylic acid, dialkyl esters of 1,4-cyclohexanedicarboxylic acid and mixtures thereof.

35. The composition of claim 28, wherein said thermoplastic resin composition comprises structural units derived from polyester and polycarbonate in a range of about 25-75 percent by weight of polyester and 75-25 percent by weight of polycarbonate.

36. The composition of claim 28, wherein said thermoplastic resin composition has a glass transition in the range of between about 70° C. and about 60° C.

37. An article comprising the composition of claim 28.

38. A process to prepare a thermoplastic resin composition comprising: structural units derived from a substituted or unsubstituted polycarbonate and a copolymer composition comprising: structural units derived from a substituted or unsubstituted diacid, a substituted or unsubstituted diol and an ester amide, wherein said ester amide comprises composition of the formula:
Y—R—X;
wherein R is independently selected from the group consisting of a substituted or unsubstituted alkenyl, allyl, alkyl, aryl, aralkyl, alkaryl, or cycloalkyl;
X is of the formula: 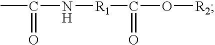
wherein R₁ and R₂ are independently selected from the group consisting of a substituted and unsubstituted alkenyl, allyl, alkyl, aryl, aralkyl, alkaryl, or cycloalkyl groups;
Y is independently selected from a group consisting of said X, COOR3 group wherein R3 independently selected from the group consisting of a substituted and unsubstituted alkenyl, allyl, alkyl, aryl, aralkyl, alkaryl, or cycloalkyl groups, and wherein said process comprises:
a. mixing the polycarbonate and copolymer to form a mixture
b. heating said mixture to form (optically) clear thermoplastic resin composition.

39. The method according to claim 38, wherein said mixing may optionally be carried out at in temperature range between about 200° C. and about 300° C.

40. The method according to claim 38, wherein said heating is carried out at in temperature range between about 210° C. and about 280° C.

41. The process of claim 38, further comprises the addition of a stabilizing additive.

42. The process of claim 38, wherein said acidic stabilizing additive is selected from the group consisting of anti-oxidants, flame retardants, reinforcing materials, colorants, mold release agents, fillers, nucleating agents, UV light stabilizers, heat stabilizers, lubricants, antioxidants flame retardants, pigments or combinations thereof

43. The process of claim 38, wherein said stabilizing additive is present at a level from about 2 to about 30 percent by weight based on the total weight of said composition.

44. The process of claim 38, wherein said diol is selected from the group consisting of atoms ethylene glycol; propylene glycol, pentane diol; dipropylene glycol; 2-methyl-1,5-pentane diol; 1,6-hexane diol; dimethanol decalin, dimethanol bicyclo octane; 1,4-cyclohexane dimethanol and particularly its cis- and trans-isomers; triethylene glycol; 1,10-decane diol; and mixtures thereof.

45. The process of claim 38, wherein said diacid is selected from the group consisting of linear acids, cycloaliphatic acids, bicyclo aliphatic acids, decahydro naphthalene dicarboxylic acids, norbomene dicarboxylic acids, bicyclo octane dicarboxylic acids, 1,4-cyclohexanedicarboxylic acid, adipic acid, azelaic acid, dicarboxyl dodecanoic acid, and succinic acid, dialkyl esters, diaryl esters, anhydrides, salts, acid chlorides, acid bromides, and mixtures thereof.
